(19) United States
(12) Patent Application Publication
(10) Pub. No.: US 2018/0198303 A1
(43) Pub. Date: Jul. 12, 2018

(54) PORTABLE AIR COMPRESSOR WITH DETACHABLE MULTI-FUNCTIONAL START POWER SUPPLY

(71) Applicant: DONGGUAN RICHTEK ELECTRONICS CO., LTD., Dongguan, Guangdong (CN)

(72) Inventor: Ken YANG, Dongguan, Guangdong (CN)

(73) Assignee: c/o Dongguan Richtek Electronics Co., Ltd., Dongguan, Guangdong (CN)

(21) Appl. No.: 15/120,518

(22) PCT Filed: Aug. 28, 2014
(86) PCT No.: PCT/CN2014/085453

§ 371 Date: Aug. 20, 2016

(30) Foreign Application Priority Data
Aug. 19, 2014 (CN) 201410408296.0

(51) Int. Cl. H02J 7/00; F04B 39/14; F04B 35/06

(52) U.S. Cl. CPC H02J 7/0068; F04B 39/14; F04B 35/04; H02J 7/0052; F04B 35/06

(57) ABSTRACT

The present application relates to a portable air compressor with a detachable multi-functional start power supply. The air compressor comprises an air compressor body (10), an air pump and a motor both provided inside the air compressor body (10) and electrically connected to each other, and a power supply circuit. The power supply circuit comprises a circuit for the air compressor body, a consumption circuit for the portable power supply and a charging circuit for the portable power supply. The air compressor body (10) also comprises a detachable multi-functional portable power supply (20) which can supply power to the air compressor when there are other power supply devices provided outdoor. A charging port (24) and a consumption socket (25) are provided on the multi-functional portable power supply, so that the multifunctional portable power supply can be detached to independently serve as portable power supplies for electronic devices such as cell phones and as emergency start power supplies for vehicle batteries, and can also provide a DC 12V voltage. The detached multi-functional portable power supply (20) is equivalent to a normal portable power supply in size. Such a multi-functional portable power supply is small in size and convenient to move and use, integrates multiple purposes and multiple functions, is convenient to carry, and enables a user to carry fewer objects when going out.

### TECHNICAL FIELD

The present application belongs to the technical field of portable air compressors, and particularly relates to a portable air compressor with a detachable multi-functional start power supply.

### BACKGROUND

With the improvement of living quality, portable air compressors have been increasingly applied to daily life, for example, for inflating tires of bicycles and vehicles, and inflating airbeds, air seats and the like in a camping trip. Multi-functional portable power supplies are one of necessary apparatus when going out. At present, multi-functional portable power supplies capable of providing a plurality of voltages are available. This kind of portable power supplies can not only provide power to electronic devices, but also serve as a start power supply for vehicle batteries. However, people always tend to carry objects as few as possible for outdoor activities. Accordingly, portable air compressors and multi-functional portable power supplies are being developed in a tendency of portability and universality.

Among the existing portable air compressors, hand-held air compressors are used extensively. However, such hand-held air compressors occupy a relatively large space, and are thus inconvenient to carry. Currently, there are box-shaped miniature portable air compressors, which are compact in structure and convenient to carry and occupy a small space. Such box-shaped miniature portable air compressors mainly comprise two types: box-shaped miniature portable air compressors with batteries and direct plug-in box-shaped miniature portable air compressors. With regard to a miniature portable air compressor with batteries, the operating power thereof is provided by the batteries. However, the electric capacity of the batteries is limited, and such limitation is disadvantageous for long-time continuous operation of the air compressor and brings a relatively high application cost. With regard to compressors with batteries in the prior art, batteries are generally provided inside a housing of an air compressor, and the batteries must be used together with the air compressor. In contrast, with regard to a direct plug-in miniature air compressor, the operating power is supplied by a DC 12V power supply from an automobile cigarette lighter. Such a direct plug-in miniature air compressor has a high requirement on the occasion. In the absence of power supplied by a DC 12V from the automobile, the air compressor cannot be applied, and it is thus inconvenient for application. In addition, most of the portable air compressors in the prior art are simple in function, while products with diverse functions are inconvenient to carry and apply.

### SUMMARY

The present application overcomes shortcomings in the prior art and provides a portable air compressor with a detachable multi-functional start power supply, the power of which can be supplied by a DC 12V from an automobile cigarette lighter and also by a multi-functional portable power supply. In addition, power can be provided to the multi-functional portable power supply by the DC 12V from the automobile cigarette lighter. This air compressor can meet various requirements from users due to its compact structure, convenient application and diverse function.

To solve the technical problems mentioned above, the present application employs the following technical solution.

A portable air compressor with a detachable multi-functional start power supply is provided, comprising an air compressor body, an air pump and a motor both provided inside and electrically connected to the air compressor body, and a power supply circuit; the air compressor body comprises a detachable multi-functional portable power supply; the power supply circuit comprises a circuit for the air compressor body, a consumption circuit for the portable power supply and a charging circuit for the portable power supply, with electrical connection structures being provided between the consumption circuit for the portable power supply and the circuit for the air compressor body and between the charging circuit for the portable power supply and the circuit for the air compressor body; when the multi-functional portable power supply is mounted in the air compressor body, the consumption circuit for the portable power supply and the charging circuit for the portable power supply are electrically connected to the circuit for the air compressor body by the electrical connection structures, and when the multi-functional portable power supply is removed, the electrical connection structures are disconnected; and a charging port and a consumption socket are provided on the multi-functional portable power supply.

Further, the electrical connection structure comprises an elastic anode sheet, an elastic cathode sheet, an anode contact and a cathode contact, the elastic anode sheet being resisted against the anode contact and the elastic cathode sheet being resisted against the cathode contact.

Further, the air compressor body is a cube in shape, and the multi-functional portable power supply is arranged at one end portion of the air compressor body.

Further, the multi-functional portable power supply and the air compressor body form a slidable clamping structure.

Further, at least two shoulders are provided oppositely at one end of the air compressor body; protrusions are provided at interval on an inner side of the shoulder, blocks are provided at interval on the multi-functional portable power supply correspondingly to the protrusions, and the portable power supply is clamped on the air compressor body by the coordination between the blocks and the protrusions; and the elastic anode sheet and the elastic cathode sheet are in close contact with the anode contact and the cathode contact, respectively.

Further, a stopper for limiting the position of the multi-functional portable power supply is provided at one end of the shoulder. Further, a locking mechanism for locking the multi-functional portable power supply is also provided on the air compressor body. Further, an illuminating device is also provided on the multi-functional portable power supply, an encoder knob is provided on the illuminating device, and each stage of the encoder knob corresponds to light of different colors and brightness.

Further, an interface capable of acquiring electricity for a vehicle battery is provided on the multi-functional portable power supply.

Further, the charging port is a USB charging port, and the consumption socket is a USB consumption socket. When compared with the prior art, the present application has the following advantageous effects.

The portable air compressor with a detachable multi-functional start power supply comprises an air compressor body and an air pump and a motor both provided inside and electrically connected to the air compressor body. In addition, a detachable multi-functional portable power supply is also provided on the power supply circuit. The power supply circuit comprises a circuit for the air compressor body, a consumption circuit for the portable power supply and a charging circuit for the portable power supply. Electrical connection structures are provided between the consumption circuit for the portable power supply and the circuit for the air compressor body and between the charging circuit for the portable power supply and the circuit for the air compressor body. When the multi-functional portable power supply is mounted on the air compressor body, the consumption circuit for the portable power supply and the charging circuit for the portable power supply are connected to the circuit for the air compressor body by the electrical connection structures. Here, not only the DC 12V from the traditional automobile cigarette lighter can be used to supply power to the compressor and to charge the multi-functional portable power supply, but also the multi-functional portable power supply can be used to supply power to the air compressor. When the multi-functional portable power supply is removed, the electrical connection structures are disconnected. Here, the DC 12V from the automobile cigarette lighter can be used to supply power to the air compressor, which is very convenient for use. A charging port and a consumption socket are also provided on the multi-functional portable power supply. With regard to the present application, the portable power supply can be removed to be used to charge and discharge electricity separately without the circuit for the air compressor body. When combined with different voltage transformation circuits, it can also serve as different voltage power supplies, for example, portable power supplies for small electronic devices such as cell phones, laptops and the like, power supplies for vehicle batteries, or DC 12V power supply. When compared with the existing technology in which a consumption socket is provided on a housing of an air compressor and the battery is not detachable, the detached multi-functional portable power supply is equivalent to a normal portable power supply in size. Such a multi-functional portable power supply is small in volume, convenient to move and use, diverse in function and convenient to carry, and thus frees a user of the trouble to go everywhere with the ponderous power supply station. In this way, user experiences a more comfortable service, and carries fewer objects when going out. When it is used as a multi-functional portable power supply separately, the multi-functional start power supply can be charged by the charging port, and it is thus very convenient for use.

Apart from serving as a small power supply station for various power consumption devices, the multi-functional portable power supply can also acquire electricity for automobile batteries and supply power of various voltages and currents. In this way, multiple functions are integrated to the maximum, and it is thus extremely convenient for application.

An illuminating device is also provided on the multi-functional start power supply. An encoder knob is provided on the illuminating device, and stages of the encoder knob can be used to select indicator light (sos, white light and red flash, et. al.). The multi-functional portable power supply can serve as an illuminating device. The multi-functional portable power supply can be applied for multiple purposes, has multiple functions, and is convenient to carry.

### BRIEF DESCRIPTION OF THE DRAWINGS

The accompanying drawings are provided for further understanding of the present application, and explain the present application together with embodiments of the present application, instead of limiting the present application. In the accompanying drawings:

FIG. 1 is a schematic structure diagram of a portable air compressor with a detachable multi-functional start power supply according to Embodiment 1 of the present application;

FIG. 2 is a schematic structure diagram of the portable air compressor with a detachable multi-functional start power supply according to Embodiment 2 of the present application;

FIG. 3 is a schematic structure diagram of the portable air compressor with a detachable multi-functional start power supply according to Embodiment 2 of the present application, from another view;

FIG. 4 is a schematic structure diagram of the portable air compressor with a detachable multi-functional start power supply according to Embodiment 3 of the present application;

FIG. 5 is a schematic structure diagram of the portable air compressor with a detachable multi-functional start power supply according to Embodiment 3 of the present application, from another view; and

FIG. 6 is a schematic structure diagram of the portable air compressor with a detachable multi-functional start power supply according to Embodiment 4 of the present application,

wherein:
10: air compressor body;
11: shoulder;
111: protrusion;
112: stopper;
121: projection;
122: connecting sheet;
131: slider;
132: position-limiting block;
133: spring;
134: slider hole;
135: position-limiting hole;
141: L-shaped hook;
142: button;
143: button hole;
20: multi-functional portable power supply;
21: block;
22: groove;
23: illuminating device;
24: charging port;
25: consumption socket; and
26: L-shaped groove.

### DETAILED DESCRIPTION

The preferred embodiments of the present application will be described with reference to the accompanying drawings below. It should be understood that the preferred embodiments described here are merely used to describe and explain the present application and not intended to limit the present application.

### Embodiment 1

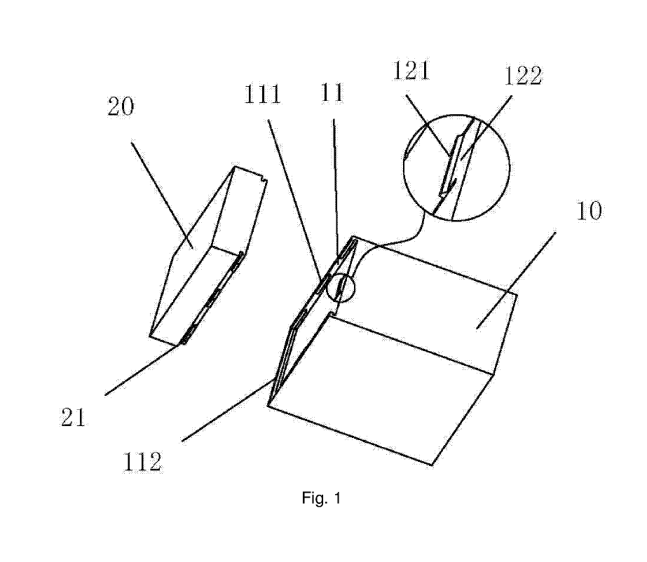

As shown in FIG. 1, the portable air compressor with a multi-functional detachable start power supply according to the present application comprises an air compressor body 10 and an air pump and a motor (not shown in the drawing) both provided within the air compressor body 10 and electrically connected to each other, and a power supply circuit. A plug (not shown in the drawing) for connecting the DC 12V power supply is provided on the air compressor body 10 and can be connected to an automobile cigarette lighter. The power supply circuit comprises a circuit for the air compressor body, a consumption circuit for the multi-functional portable power supply 20 and a charging circuit for the portable power supply. A detachable multi-functional portable power supply 20 is also provided on the air compressor body 10. Electrical connection structures (not shown in the drawing) are provided between the charging circuit for the portable power supply and the circuit for the air compressor body 10 and between the consumption circuit for the portable power supply and the circuit for the air compressor body 10. The charging circuit for the portable power supply and the consumption circuit for portable power supply are electrically connected to the circuit for the air compressor body 10 by the electrical connection structures. When the multi-functional portable power supply 20 is mounted on the air compressor body 10, the consumption circuit for the portable power supply and the charging circuit for the portable power supply are electrically connected to the circuit for the air compressor body by the electrical connection structures, and when the multi-functional portable power supply 20 is removed, the electrical connection structures are disconnected.

The electrical connection structure comprises an elastic anode sheet and an elastic cathode sheet provided on the circuit for the air compressor body. An anode contact and a cathode contact are provided on the consumption circuit for the portable power supply and the charging circuit for the portable power supply, with the elastic anode sheep being resisted against the anode contact and the elastic cathode sheet being resisted against the cathode contact (not shown in the drawing).

As shown in FIG. 1, the air compressor body 10 is a cube in shape. The multi-functional portable power supply 20 is provided on one end of the air compressor body 10, and a new cube is formed after the multi-functional portable power supply 20 and the air compressor body 10 are combined.

The multi-functional portable power supply 20 and the air compressor body 10 form a slidable clamping structure. The structure is easy to be assembled and disassembled, and is thus convenient for use.

At least two shoulders 11 are provided oppositely at one end of the air compressor body 10; protrusions 111 are provided at interval on an inner side of the shoulder 11, blocks 21 are provided at interval on the multi-functional portable power supply 20 correspondingly to the protrusions 111, and the portable power supply 20 is clamped on the air compressor body 10 by the coordination between the blocks 21 and the protrusions 111; and the elastic anode sheet and the elastic cathode sheet are in close contact with the anode contact and the cathode contact, respectively. The plurality of protrusions 111 and blocks 21 form a plurality of support points for clamping, so that the multi-functional portable power supply 20 is fixedly and firmly clamped with the air compressor body 10. The electrical connection structure located on a contact surface between the multi-functional portable power supply 20 and the air compressor body 10 is especially in close contact, which ensures that the multi-functional portable power supply 20 and the circuit are in excellent contact.

A stopper 112 for limiting the position of the multi-functional portable power supply 20 is provided at one end of the two shoulders 11. The blocks 112 are configured to limit the position at which the multi-functional portable power supply 20 is slidingly inserted into the air compressor body 10.

A locking mechanism for locking the multi-functional portable power supply 20 is also provided on the air compressor body 10. The locking mechanism of present embodiment is formed of a protrusion 121 provided at and protruded from an end surface of the air compressor body 10 and a groove 22 provided on the multi-functional portable power supply 20. The protrusion 121 is connected to the air compressor body 10 by a connecting sheet 122 which can be elastically deformed. The connecting sheet 122 can be slightly deformed by an external force so that the protrusion 121 can be clamped into and removed from the groove 22.

The multi-functional portable power supply 20 can acquire electricity for a vehicle battery. High-current connecting wires specified for acquiring electricity for a vehicle battery is also provided on present device.

### Embodiment 2

A main technical solution of present embodiment is the same as that of Embodiment 1. Features not explained in present embodiment will refer to those in Embodiment 1, and will not be repeated here. The difference between present embodiment and Embodiment 1 lies in that:

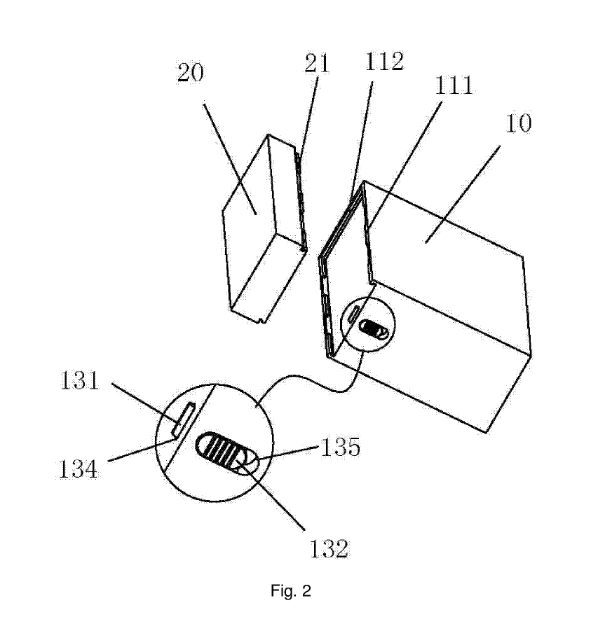

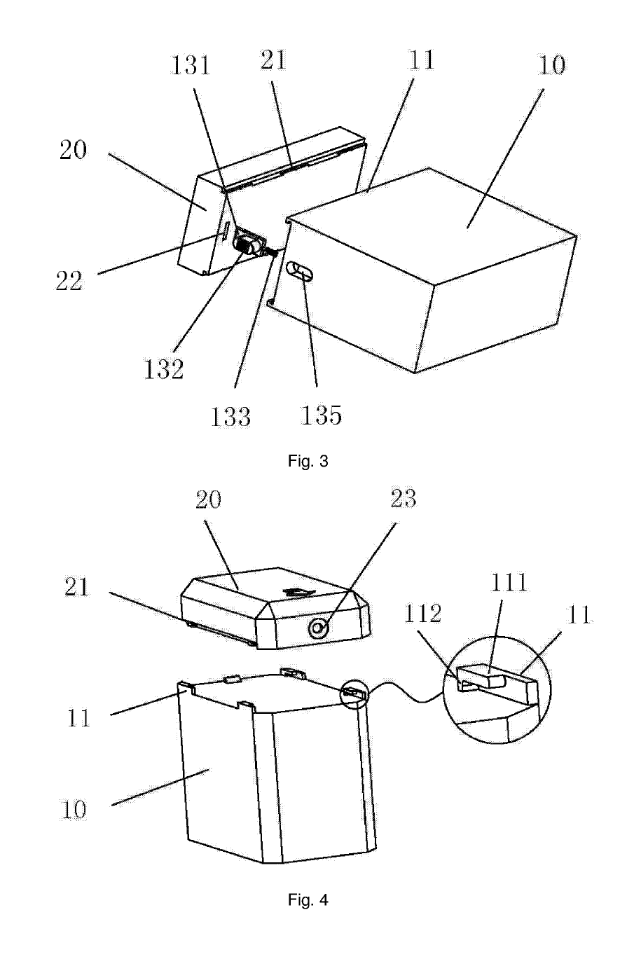

As shown in FIG. 2 and FIG. 3, the locking mechanism employed in present embodiment is formed of a slider 131 provided inside the air compressor body 10 and a spring 133 propping the slider 131, and also comprises a groove 22 formed on the multi-functional portable power supply 20. A position-limiting block 132 for limiting the position of the slider 131 is provided on the slider 131, and a slider hole 134 is formed on an end surface of the air compressor body 10. A position-limiting hole 135 is formed on a side of the air compressor body 10, and the position-limiting block 132 is provided inside the position-limiting hole 135. The slider 131 is provided inside the slider hole 134. The spring 133 is arranged on the bottom of the slider 131, and the slider 131 is pushed by the spring 133 to move along the slider hole 134. When locking and position-limiting are required, the spring 133 props up the slider 131 and the slider 131 is inserted into the groove 22 through the slider hole 134. When the multi-functional portable power supply 20 is detached, the position-limiting block 132 is moved toward the spring 133 with hands, and the slider 131 retracts from the inside of the groove 22. Here, the multi-functional portable power supply 20 can be detached by sliding the multi-functional portable power supply 20 away from the stopper 112.

### Embodiment 3

A main technical solution of present embodiment is the same as that of Embodiment 1. Features not explained in present embodiment will refer to those in Embodiment 1, and will not be repeated here. The difference between present embodiment and Embodiment 1 lies in that:

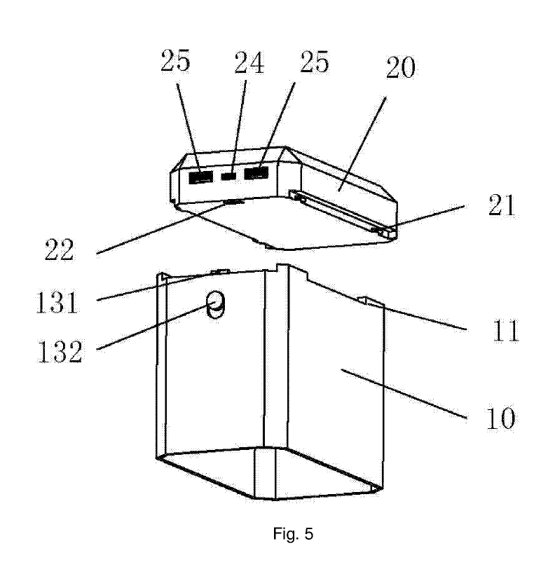

As shown in FIG. 4, an illuminating device 23 is also provided on the multi-functional portable power supply 20. An encoder knob is provided on the illuminating device 23, and stages of the encoder knob can be used to select indicator light (sos, white light and red flash, et. al). The multi-functional portable power supply 20 can serve as an illuminating device 23. As shown in FIG. 5, a charging port 24 and a consumption socket 25 are also provided on the multi-functional portable power supply 20. A second charging circuit for the portable power supply electrically connected to the charging port 24, and a second consumption circuit for the portable power supply electrically connected to the consumption socket 25, are also provided inside the multi-functional portable power supply 20. The portable power supply can serve as a common multi-functional portable power supply 20 to charge electronic devices such as cell phones and IPADs. The multi-functional portable power supply can be applied for multiple purposes, has multiple functions, and is convenient to use.

As shown in FIG. 4 and FIG. 5, there are four shoulders 11 in present embodiment, which are arranged at four corners of an end surface of the air compressor body 10, respectively. A protrusion 111 is provided for each shoulder 11; and a stopper 112 is provided at one end of each shoulder 11 for positioning the multi-functional portable power supply 20. A block 21 is provided at the four corners of the multi-functional portable power supply 20 respectively corresponding to the positions of the four shoulders 11, and the multi-functional portable power supply 20 is clamped by the coordination between the blocks 21 and the protrusions 111. The structure is firm in connection and convenient for disassembly.

### Embodiment 4

A main technical solution of present embodiment is the same as that of Embodiment 1. Features not explained in present embodiment will refer to those in Embodiment 1, and will not be repeated here. The difference between present embodiment and Embodiment 1 lies in that:

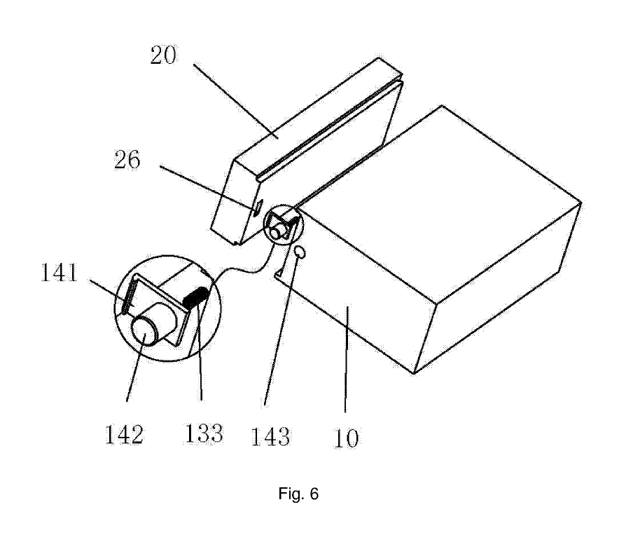

As shown in FIG. 6, the locking mechanism of present embodiment is formed of an L-shaped hook 141, a button 142 and a spring 133 provided inside the air compressor body 10, and an L-shaped groove 26 provided on the bottom of the multi-functional portable power supply 20. A button hole 143 and a hook hole are formed on the air compressor body 10. The button 142 is arranged inside the button hole 143, and the hook penetrates through the hook hole. The button 142 is fixedly connected to a side of the L-shaped hook 141, and the spring 133 is resisted against the other side of the L-shaped hook 141. The hook can be pushed by the spring 133 to move by a distance in the hook hole horizontally. There is a locking site at one side of the hook hole and an unlocking site on the other side. When locking, the button 142 is pressed down, the spring 133 is compressed, the L-shaped hook 141 is located at the unlocking site, and the L-shaped hook 141 is inserted into the L-shaped groove 26; and when the button 142 is released, the spring 133 returns back to its original position, here the L-shaped hook 141 is pushed to reach the locking site, the L-shaped groove 26 is hooked by the L-shaped hook 141, and the multi-functional portable power supply 20 is locked. When unlocking, the above steps are repeated reversely.

Finally, it should be noted that, the foregoing descriptions are merely preferred embodiments of the present application, and are not intended to limit the present application. Although the present application has been described in detail with reference to the embodiments, those skilled in the art can still make modifications to the technical solutions recorded in the foregoing embodiments, or make equivalent replacements to partial technical features therein. Any modifications, equivalent replacements, and improvements made within the spirit and principle of the present application should fall into the protection scope of the present application.

1. A portable air compressor with a detachable multi-functional start power supply, comprising an air compressor body, an air pump and a motor both provided inside the air compressor body and electrically connected to each other, and a power supply circuit; wherein the air compressor body comprises a detachable multi-functional portable power supply; the power supply circuit comprises a circuit for the air compressor body, a consumption circuit for the portable power supply and a charging circuit for the portable power supply, with electrical connection structures being provided between the consumption circuit for the portable power supply and the circuit for the air compressor body and between the charging circuit for the portable power supply and the circuit for the air compressor body; when the multi-functional portable power supply is mounted in the air compressor body, the consumption circuit for the portable power supply and the charging circuit for the portable power supply are electrically connected to the circuit for the air compressor body by the electrical connection structures, and when the multi-functional portable power supply is removed, the electrical connection structures are disconnected; and a charging port and a consumption socket are provided on the multi-functional portable power supply.

2. The portable air compressor with a detachable multi-functional start power supply according to claim 1, wherein the electrical connection structure comprises an elastic anode sheet, an elastic cathode sheet, an anode contact and a cathode contact, the elastic anode sheet being resisted against the anode contact and the elastic cathode sheet being resisted against the cathode contact.

3. The portable air compressor with a detachable multi-functional start power supply according to claim 2, wherein the air compressor body is a cube in shape, and the multi-functional portable power supply is arranged at one end portion of the air compressor body.

4. The portable air compressor with a detachable multi-functional start power supply according to claim 3, wherein the multi-functional portable power supply and the air compressor body form a slidable clamping structure.

5. The portable air compressor with a detachable multi-functional start power supply according to claim 4, wherein at least two shoulders are provided oppositely at one end of the air compressor body; protrusions are provided at interval on an inner side of the shoulder, blocks are provided at interval on the multi-functional portable power supply correspondingly to the protrusions, and the multi-functional portable power supply is clamped on the air compressor body by the coordination between the blocks and the protrusions; and the elastic anode sheet and the elastic cathode sheet are in close contact with the anode contact and the cathode contact, respectively.

6. The portable air compressor with a detachable multi-functional start power supply according to claim 5, wherein a stopper for limiting the position of the multi-functional portable power supply is provided at one end of the shoulder.

7. The portable air compressor with a detachable multi-functional start power supply according to claim 4, wherein a locking mechanism for locking the multi-functional portable power supply is also provided on the air compressor body.

8. The portable air compressor with a detachable multi-functional start power supply according to claim 1, wherein an illuminating device is also provided on the multi-functional portable power supply, an encoder knob is provided on the illuminating device, and each stage of the encoder knob corresponds to light of different colors and brightness.

9. The portable air compressor with a detachable multi-functional start power supply according to claim 1, wherein an interface capable of acquiring electricity for a vehicle battery is provided on the multi-functional portable power supply.

10. The portable air compressor with a detachable multi-functional start power supply according to claim 1, wherein the charging port is a USB charging port, and the consumption socket is a USB consumption socket.
